(19) United States
(12) Patent Application Publication
(10) Pub. No.: US 2023/0300431 A1
(43) Pub. Date: Sep. 21, 2023

(54) DEVICE, SYSTEM AND METHOD FOR ACQUIRING A HYPERSPECTRAL IMAGE

(71) Applicant: GLANA SENSORS AB, Linköping (SE)

(72) Inventors: Jörgen AHLBERG, Linköping (SE); Ingemar RENHORN, Linköping (SE)

(73) Assignee: GLANA SENSORS AB, Linköping (SE)

(21) Appl. No.: 18/017,757

(22) PCT Filed: Jul. 14, 2021
(86) PCT No.: PCT/EP2021/069667

§ 371 Date: Jan. 24, 2023

(30) Foreign Application Priority Data
Jul. 24, 2020 (SE) 2050919-6

(51) Int. Cl. H04N 23/10; H04N 23/55; H04N 23/51; G02B 7/00

(52) U.S. Cl. CPC H04N 23/10; H04N 23/55; H04N 23/51; G02B 7/006

(57) ABSTRACT

A filter device for acquiring a hyperspectral image comprises a filter device frame, an optical filter, and an actuator, configured to control, relative to the frame, a position of the optical filter along a first direction. The optical filter presents continuously variable transmission wavelength along the first direction.

### TECHNICAL FIELD

The present disclosure relates to a device, a system and a method for acquiring a hyperspectral image.

### BACKGROUND

A camera is an optical device used to generate images representing an object or a scene. A typical camera has a camera body enclosing one or a set of lenses to capture an image on a light-sensitive surface, e.g., a photographic film or a digital sensor, within the camera body. The incoming light typically passes through the lenses and through a small hole, i.e. an aperture, which limits the amount of light that reaches the light-sensitive surface.

For a digital camera, the incoming light may be directed onto a two-dimensional sensor, configured to generate an image made up of a plurality of pixels. At each pixel, the light may be sampled at several different wavelength bands simultaneously, such that each pixel will comprise measurements at the different wavelength bands. Such images are referred to as “multispectral images”. For example, a typical consumer camera samples three wavelength bands corresponding to red, green, and blue colours, respectively. Thus, each pixel of the generated image has information about the incoming light at these three wavelength bands. That is, the images generated by the consumer camera are multispectral images. Images containing information about more than three wavelength bands are referred to as “multispectral images”. Images containing information about more than 5-10 wavelength bands, typically about 10-200 or 20-200 wavelength bands, are often referred to as “hyperspectral images”.

Each pixel of the hyperspectral image comprises a (spectral) vector of measurements at different wavelength bands. The vector, also known as a spectral signature, of the pixel, may have information of the material(s) of one part of the scene represented by the pixel of the image. The vector, or the spectral signature, may be considered as a high-dimensional generalization of the concept of colour. Since different materials may reflect and emit different amounts of light at different wavelengths, the spectral signature can be used to determine the material of that part of the scene represented by the pixel. Consequently, the materials of all parts of the scene may be determined. Thus, the hyperspectral image can be used for object detection, classification, and recognition.

Hyperspectral imaging exploitation has been extended to many new fields, including military and civilian remote sensing, such as military reconnaissance, mines detection, precision agriculture, environmental monitoring, and industrial monitoring, such as food inspection. For example, different types or conditions of vegetation may be distinguished for environmental monitoring and precision agriculture. Natural and artificial greenery may be distinguished.

However, the cameras capable of acquiring hyperspectral images are very expensive, compared with existing consumer (and even professional) RGB cameras, due to their complexity and lack of large-scale manufacturing. Further, the hyperspectral cameras have a relatively large size, comparing to existing consumer RGB cameras.

There is a need for smaller and preferably also more inexpensive devices for acquiring hyperspectral images, which can acquire hyperspectral images of an acceptable quality.

### SUMMARY

An object of the present disclosure is to provide a concept that makes hyperspectral imaging more user friendly and affordable.

The invention is defined by the appended independent claims, with embodiments being set forth in the dependent claims, in the following description and in the drawings.

According to a first aspect, there is provided a filter device for acquiring a hyperspectral image. The device comprises a filter device frame, an optical filter, and an actuator, configured to control, relative to the frame, a position of the optical filter along a first direction. The optical filter presents continuously variable transmission wavelength along the first direction.

The frame is a structure which provides a base and/or an enclosure for the filter device. Hence, the frame may be a skeleton structure on which the actuator and the optical filter are mounted. Alternatively, the frame may be a housing enclosing the actuator and the optical filter.

An optical filter is a device selectively transmitting light of different wavelengths in an optical path. A commercial optical filter is usually implemented as a glass or a plastic plate.

An optical filter having variable transmission wavelength along a direction thereof is known as such.

In one embodiment, the first direction is a linear direction.

Alternatively, the first direction may be circular, such as along the circumference of a circular disc.

The transmission wavelength may vary linearly along the first direction. Alternatively, the transmission wavelength may vary non-linearly, such as exponentially along the first direction.

By controlling the position of the optical filter relative to the frame by means of an actuator, it is possible to transmit light of different wavelength through one optical filter and acquire a plurality of images with the filter in different positions relative to a camera, each position corresponding to a certain transmission wavelength.

Moreover, if such a filter is applied to a camera having a very small aperture and/or lens, such as a camera of the type used in smart phones, the variation in transmission wavelength over the diameter of the aperture and/or lens, is, for many applications, negligible. Hence, by using a filter having continuously variable transmission wavelength together with a very small camera aperture/lens, it is possible to achieve a large number of wavelength bands.

Currently, filter lengths along the first direction of about 30-100 mm, preferably 30-60 mm are contemplated.

For example, if a filter having an effective length of 36 mm along the direction presents continuously variable transmission wavelength, e.g., the first direction, is used with a camera aperture of 2 mm, it is possible to achieve an 18-band hyperspectral image capture, wherein the 18 bands are non-overlapping.

Even though, at each such band, there will be some variance in the filter wavelength transmission along the first direction, with a very small aperture, such as on the order of 1-3 mm, the variation in wavelength transmission over the image width (or height, depending on how the filter is positioned relative to the filter sensor) may be small enough to be accepted as negligible for each individual image, and/or possible to manage by calibrating a spectral variation over the image.

As another example, if 50% overlap is accepted, the same optical filter and camera aperture would provide a 36-band hyperspectral image capture.

Hence, a large number of bands may be achieved using a compact and less expensive imaging device.

The term “hyperspectral” is typically used to designate cameras capable of recording more than three wavelength bands.

A visible spectrum, or a visible wavelength band, may refer to the portion of the electromagnetic spectrum that is visible to the human eyes. Electromagnetic radiation in this range of wavelengths is called visible light. A typical human eye will respond to wavelengths from about 380 to 740 nanometres (nm), which corresponds to a frequency band of 405-790 THz.

The spectral bands of a hyperspectral camera can be within or beyond the visible wavelengths. For example, the spectral bands ranges could be Visible and Near-infrared (VNIR), Short-wavelength infrared plus Mid-wavelength infrared (SWIR+MWIR), or Long-wavelength infrared (LWIR).]

The optical filter may have a constant transmission wavelength in a second direction, perpendicular to the first direction.

The transmission wavelength may vary between a lower transmission wavelength and an upper transmission wavelength, wherein the upper transmission wavelength is greater than the lower transmission wavelength.

The transmission wavelength may vary over a range of at least one of 200-250 nm, 250-300 nm, 300-350 nm, 350-400 nm, 400-450 nm or 450-500, 500-550 nm, 550-600 nm, 600-650 nm, 650-700 nm, 700-750 nm, 750-800 nm, 800-850 nm, 850-900 nm, 900-950 nm, 950-1000 nm, 1000-1050 nm, 1050-1100 nm, 1100-1150 nm or 1150-1200 nm, 1200-1250 nm, 1250-1300 nm, 1300-1350 nm, 1350-1400 nm, 1400-3000 nm (SWIR), 3000-8000 nm (MWIR), 8000-15000 nm (LWIR) or 15000-1000000 nm (FIR).

The first direction may be linear and an effective filter width across the first direction may be less than 10% of an effective filter length along the first direction, preferably less than 6% or less than 5%.

The effective filter length is the length of the filter that is useful for filtering light. Hence, any edge portion which is completely non-transparent or completely transparent to all wavelengths would be outside the “effective filter length”. This applies mutatis mutandis to the term “effective filter width”.

Alternatively, the first direction may be circular.

The filter device may further comprise a filter controller, configured to receive a trigger signal, and in response to the trigger signal, provide a control signal to the actuator to cause the optical filter to move along said first direction.

The filter device may further comprise a calibration device, configured to provide light of at least one predetermined wavelength through the optical filter.

By providing a light of a predetermined wavelength through the optical filter, it is possible to determine a position along the first direction of the optical filter, which position has a transmission wavelength corresponding to the predetermined wavelength, since it would be known where along the filter that particular wavelength would be transmitted. This may be used for calibration of the filter position.

The light may be provided by a light source and optionally an optical filter device providing one or more limited transmission wavelengths or an optical reflecting device providing one or more limited reflection wavelengths. Such calibration device may be integrated with the filter device.

The filter device may further comprise a filter housing enclosing the optical filter and the actuator.

Hence, the filter device may be formed as a separate device that is configured to be arranged in the optical path of a camera, such as a dedicated camera, a smartphone camera or a tablet computer camera.

The housing may present an inlet aperture upstream of the optical filter and an outlet aperture downstream of the optical filter.

An aperture may refer to a hole or an opening through which light passing through. In some contexts, aperture may refer to a diameter of an aperture itself. The aperture may be given a linear measure, e.g., in mm, or as a ratio between the diameter of the aperture and a focal length. For example, in photography, the aperture is usually given as a ratio.

It is understood that camera apertures need not be circular. Hence, in the present context, it is the effective dimension of the aperture along the first direction which is relevant.

The filter device may further comprise a camera attachment device.

According to a second aspect, there is provided a system for acquiring a hyperspectral image. The system comprises a camera having an image sensor and a camera lens defining a camera optical axis, a filter device as described above, arranged such that the optical filter is movable across the camera optical axis, and a camera housing, enclosing said image sensor and said filter device.

The camera may be a digital camera, and may be provided in the form of a dedicated camera, in the form of a smartphone or in the form of a tablet computer. In a particular set of embodiments, the camera may be a polarimetric camera.

An optical axis may refer to a line along which there is substantially rotational symmetry in an optical system, e.g., a lens.

The optical axis may be an imaginary line that defines an optical path along which light propagates through the optical system.

An image sensor may refer to a device that detects and conveys light into electrical signals, e.g., small bursts of current, representing the information of the light it detects.

Image sensors are used in electronic imaging devices of both analog and digital types, including digital cameras, smart phones, radars, etc. The electronic image sensor is gradually replacing chemical sensors, such as a photographic film, in consumer cameras. Two main types of electronic image sensors are the charge-coupled device (CCD) and the active-pixel sensor (CMOS sensor). Both CCD and CMOS sensors are based on metal-oxide-semiconductor (MOS) technology.

A camera having a standard type RGB image sensor may be used also for acquiring hyperspectral images, since, in some such cameras, the filters for the individual colors transmit not only the respective color (red, green, blue), but also wavelengths of a part of the near infrared spectrum.

It would also be possible to provide a camera having a modified image sensor, in the sense that the red, green and blue filters are removed.

In some embodiments, the camera may be a monochrome CMOS camera.

According to a third aspect, there is provided a system for acquiring a hyperspectral image. The system comprises a camera having an image sensor and a camera lens defining a camera optical axis, a camera housing, enclosing said image sensor and said camera lens, and a filter device as described above, arranged such that the optical filter is movable across the camera optical axis. The filter housing may be releasably connectable to the camera housing.

In the system an aperture dimension along the first direction, perpendicular to the optical axis may be less than 20% of an effective filter length along the first direction, preferably less than 15%, less than 10%, less than 8% or less than 6%.

The minimum aperture cross section is the smallest dimension of the aperture, typically a diameter in the case where the aperture is approximately circular.

A filter transmission wavelength of the optical filter may vary less than 30 nm, preferably less than 20 nm, less than 15 nm, less than 10 nm, less than 5 nm, less than 2 nm or less than 1 nm, over a length of the filter along the first direction, which length corresponds to the minimum aperture cross section.

A camera aperture may be 1-3 mm along the first direction, preferably 1-1.5 mm, 1.5 mm-2 mm, 2 mm-2.5 mm or 2.5 mm-3 mm.

The camera may comprise a camera controller, which is configured to control the actuator.

The filter controller may communicate with the actuator via a cable/data bus, or wireless, e.g., via communication protocols such as Bluetooth and WIFI.

The filter controller may be a separate module or integrated as a part of a processor of the camera.

According to a fourth aspect, there is provided a method of acquiring a hyperspectral image. The method comprises providing a camera having an image sensor and a camera lens defining an optical axis of the camera, providing an optical filter, having continuously variable transmission wavelength along a first direction, acquiring a first image of a scene, while the optical filter is in a first position relative to the optical axis, moving the optical filter relative to the optical axis along the first direction by means of an actuator, and acquiring a second image of the scene, while the optical filter is in a second position, spaced from the first position, relative to the optical axis.

The method may further comprise repeating the step of moving the optical filter and the step of acquiring a second image a predetermined number of times.

In the method the step of moving the optical filter may comprise moving the optical filter by a distance along the first direction which corresponds to 50-150% of an aperture dimension along the first direction, perpendicular to the optical axis.

Typically, the minimum aperture cross section may be the effective camera aperture.

The camera may be substantially stationary relative to the scene during and between said first and second acquiring steps.

Substantially stationary means that the camera is held in a fixed position relative to the scene, but for such movements as may be compensated for by mechanical and/or electronic motion compensation techniques.

The substantially stationary can be achieved by a burst mode, also known as a continuous shooting mode, a sports mode or a continuous high speed mode, of the camera. In burst mode, the camera can capture several images in quick succession, such that the movement of the camera can be ignored.

The method may further comprise receiving, by a filter controller, a trigger signal from a camera controller, and carrying out said step of moving the optical filter based on said trigger signal.

The method may further comprise carrying out a plurality of steps of moving and steps of acquiring the second image in response to a single trigger signal.

According to a fifth aspect, there is provided a method of calibrating an optical filter device. The method comprises providing a camera having an image sensor and a camera lens defining an optical axis of the camera, providing an optical filter, having continuously variable transmission wavelength along a first direction, using the image sensor to acquire light of at least one predetermined wavelength through the optical filter, and associating a filter position along the first direction with said predetermined wavelength.

### BRIEF DESCRIPTION OF THE DRAWINGS

FIG. 1 is a schematic diagrammatic view of a filter device 1 and a camera 2.

FIG. 2 is a schematic diagrammatic view of a camera 3 with an integrated filter device.

FIG. 3 is a schematic diagrammatic view of a filter 11.

FIG. 4 is a graph illustrating filter transmission wavelength λ as a function of position X along the filter 11.

FIG. 5 is a schematic diagrammatic view of a filter 11 according to an alternative embodiment.

### DETAILED DESCRIPTION

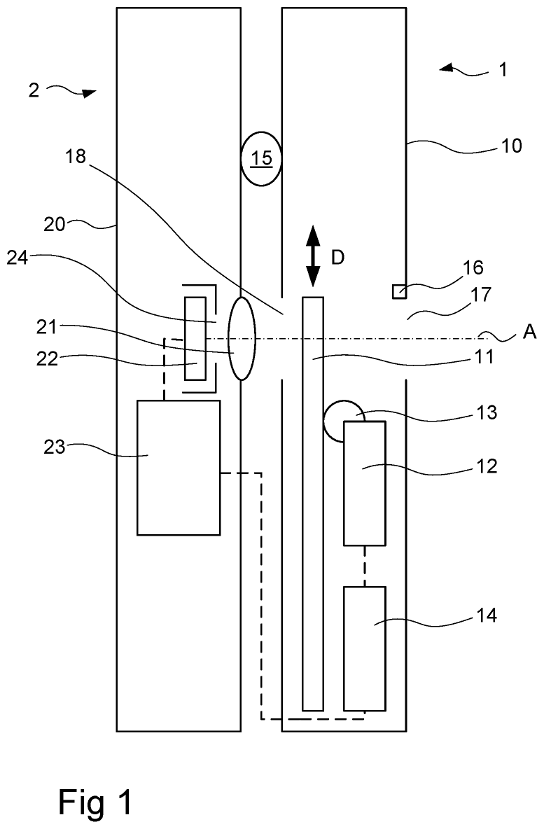

FIG. 1 schematically illustrates a filter device 1 attached to a camera 2.

The filter device 2 may comprise a filter housing 10, an optical filter 11, an actuator 12 and optionally a transmission mechanism 13. A filter controller 14 may be provided for controlling the actuator 12.

The optical filter 11 presents continuously variable transmission wavelength along a first direction. An optical filter having variable transmission wavelength along a direction thereof is known as a Continuously Variable Filter (CVF), or a Continuously Variable Bandpass Filter (CVBPF). Such optical filters may be coated with silicon dioxide and metal oxides on a single-fused silica substrate without the use of glue, color glasses or thin metal layers. For example, the company Delta Optical Thin Film NS of Horsholm, Denmark, design and manufacture such CVFs. These filters have a length along the first direction X of 36 mm and a width of 24 mm.

The filter device frame may be a structure which provides a base and/or an enclosure for the filter device 1. The filter device frame may be a skeleton structure on which the actuator 12 and the optical filter 11 are mounted.

The filter device frame may be a housing 10 enclosing the actuator 14 and the optical filter 11, as shown in FIG. 1.

In FIG. 1, the double arrow D illustrates two directions of the movement of the optical filter 11 relative to the filter device frame. The first direction may coincide with any one of the two directions of the double arrow D. In the example illustrated in FIG. 1, the optical filter 11 is slidable in a direction D, which may be parallel with a filter plane. The sliding motion is controlled by the actuator 12.

The actuator 12 may be directly connected to the optical filter 11.

Alternatively, the actuator 12 may be connected to the optical filter 11 via a transmission mechanism 13. The transmission mechanism may comprise a friction wheel, which acts against the optical filter 11. Alternatively, the transmission mechanism 13 may comprise a gearwheel, a wormwheel or the like, which may interact with a toothed rack fixed to the optical filter 11.

The filter housing 10 may present an inlet aperture 17 and an outlet aperture 19, both of which may be aligned along an optical axis A.

The optical axis A may refer to a line along which there is substantially rotational symmetry in an optical system, e.g., the lens 21. The optical axis A may be an imaginary line that defines an optical path along which light propagates through the optical system.

The inlet aperture 17 may be provided upstream of the optical filter 11 and the outlet aperture 18 may be provided downstream of the optical filter 11, as seen in the direction of incoming light along the optical axis A. An aperture may refer to a hole or an opening of any form, through which light can pass through. A typical aperture has a round form. Here, the light may pass through the inlet aperture 17, a part of the optical filter 11, and the outlet aperture 18 before reaching any image capture device, e.g., the camera 2.

The optical filter 11 may be positioned immediately upstream of the lens 21 or lens package.

The optical filter 11 may be positioned downstream of the inlet aperture, as seen along the optical axis A.

The filter device 1 may further comprise a camera connector 15, for realize a releasable connection to the camera 2. Such camera connectors are known as such, e.g. from such auxiliary lens arrangements as are available for smartphones to provide telephoto or macro photo capability.

The camera 2 may be a digital camera, and may be provided in the form of a dedicated camera, in the form of a smartphone, or in the form of a tablet computer.

The camera 2 may comprise a camera housing 20, which comprises at least one lens 21 or lens package, which defines the optical axis A and which guides incoming light towards an image sensor 22. The lens package may comprise a set of lenses, which may comprise traditional convex/concave lenses as well as various diffractive/Fresnel type lenses. It is understood that the lens or lens package may be arranged in an opening in the camera housing 20, 30.

The image sensor 22 may refer to a device that detects and conveys light into electrical signals, e.g., small bursts of current, representing the information of the light it detects. Image sensors are commonly used in electronic imaging devices of both analog and digital types, including digital cameras, smart phones, radars, etc. The electronic image sensor is gradually replacing chemical sensors, such as a photographic film, in consumer cameras. Two main types of electronic image sensors are the charge-coupled device (CCD) and the active-pixel sensor (CMOS sensor). Both CCD and CMOS sensors may be based on metal-oxide-semiconductor (MOS) technology.

A camera controller 23 may be connected to the image sensor 22.

The camera 2 may also comprise an aperture 24, for limiting the amount of light applied to the image sensor 22. The aperture 24 may be fixed or controllable by the camera controller 23. The aperture 24 may be provided between the lens 21 and the image sensor 22, as shown in FIG. 1. Alternatively, the aperture 24 may be provided upstream of the lens 21.

In some contexts, the term aperture may refer to a diameter of an aperture itself. The aperture may be given a linear measure, e.g., in mm, or as a ratio between the diameter of the aperture and a focal length. For example, in photography, the aperture is usually given as a ratio. The minimum aperture cross section may be the smallest dimension of the aperture 24, typically a diameter in the case where the aperture 24 is approximately circular.

The minimum aperture cross section perpendicular to the optical axis A may be less than 20% of an effective filter length along the first direction X, preferably less than 15%, less than 10%, less than 8% or less than 6%.

In various embodiments, filter transmission wavelength of the optical filter 11, 31, may vary on average over the entire length of the optical filter in the first direction X about 0.25 nm/mm, about 1.11 nm/mm, about 1.67 nm/mm, 2.5 nm/mm, 9.17 nm/mm. Hence, the filter transmission wavelength may vary about 0.25-2 nm/mm, about 2-4 nm/mm, about 4-10 nm/mm or about 10-15 nm/mm.

The camera aperture 24 may be 1-3 mm, preferably 1-1.5 mm, 1.5 mm-2 mm, 2 mm-2.5 mm or 2.5 mm-3 mm.

Hence, the filter transmission wavelength of the optical filter 11 may vary less than 30 nm over a length of the optical filter 11, 31 along the first direction X, which length corresponds to the minimum aperture cross section, preferably less than 20 nm, less than 10 nm, less than 5 nm, less than 2 nm or less than 1 nm.

The filter controller 14 may be configured to carry out overall control of functions and operations of the filter device 1. The filter controller 14 may include a processor, such as a central processing unit (CPU), microcontroller, or microprocessor. The filter device 1 may comprise a memory. The filter controller 14 may be configured to execute program codes stored in the memory, in order to carry out functions and operations of the filter device 1.

The memory may be one or more of a buffer, a flash memory, a hard drive, a removable medium, a volatile memory, a non-volatile memory, a random access memory (RAM), or another suitable device. In a typical arrangement, the memory may include a non-volatile memory for long term data storage and a volatile memory that functions as system memory for the filter device 1. The memory may exchange data with the filter controller 14 over a data bus. Accompanying control lines and an address bus between the memory and the filter controller 14 also may be present.

Functions and operations of the filter device 1 may be embodied in the form of executable logic routines (e.g., lines of code, software programs, etc.) that are stored on a non-transitory computer readable medium (e.g., the memory) of the filter device 1 and are executed by the filter controller 14. Furthermore, the functions and operations of the filter device 1 may be a stand-alone software application or form a part of a software application that carries out additional tasks related to the filter device 1. The described functions and operations may be considered a method that the corresponding device is configured to carry out. Also, while the described functions and operations may be implemented in software, such functionality may as well be carried out via dedicated hardware or firmware, or some combination of hardware, firmware and/or software.

The filter controller 14 may be configured to receive a trigger signal, and in response to the trigger signal, provide a control signal, which may be a series of signals, to the actuator 12 to cause the optical filter 11 to move along said first direction. The trigger signal may be received from an external device, e.g., the camera 2.

The filter controller 14 may be connected to the camera controller 23. The connection may be a wired connection, e.g., via a cable/data bus, or a wireless connection, such as Bluetooth, NFC or wi-fi.

The camera controller 23 may be a separate module or integrated as a part of a processor of the camera 2 or the device comprising the camera (such as a smartphone or tablet).

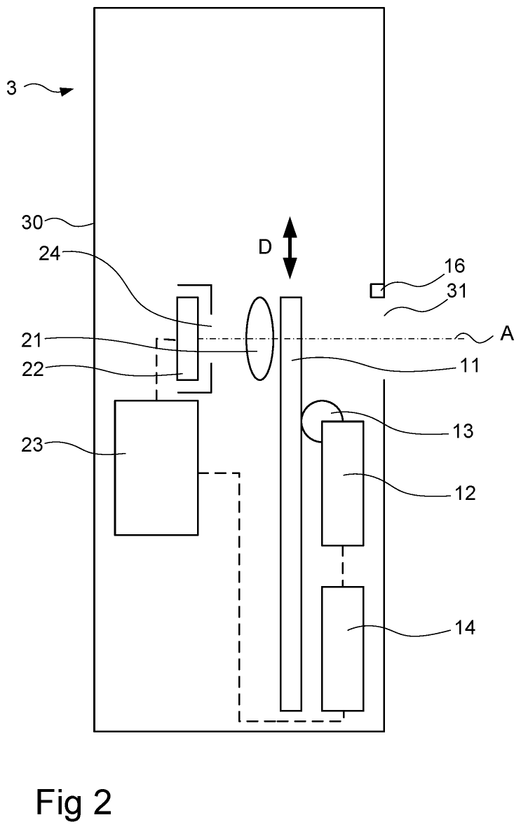

FIG. 2 schematically illustrates a camera 3 with an integrated filter device. The integrated filter device may be the same as the filter device 1 of FIG. 1.

The camera 3 comprises a camera housing 30 having an aperture 31. The camera 3 may be a digital camera, and may be provided in the form of a dedicated camera, in the form of a smartphone, or in the form of a tablet computer.

The camera 3 comprises an optical filter 11, an actuator 12 and optionally a transmission mechanism 13. A filter controller 14 may be provided for controlling the actuator 12. The camera 3 may be arranged such that the optical filter 11 is movable across a camera optical axis A, by the actuator 12.

The camera 3 may further comprise a lens or lens package 21, an image sensor 22 and a camera controller 23, like the camera described with reference to FIG. 1. The lens 21 and the image sensor 22 may define the camera optical axis A.

Furthermore, the camera 3 may comprise an aperture 24. The aperture 24 may be fixed or controllable by the camera controller 23.

The filter controller 14 may be integrated with the camera controller 23.

FIGS. 1-2 illustrate two examples of implementation of the filter device 1. In the example of FIG. 1, the filter device 1 can be used as an attachable device to the existing camera 2. In the example of FIG. 2, the filter device 1 can be provided as an integrated filter device of the camera 3.

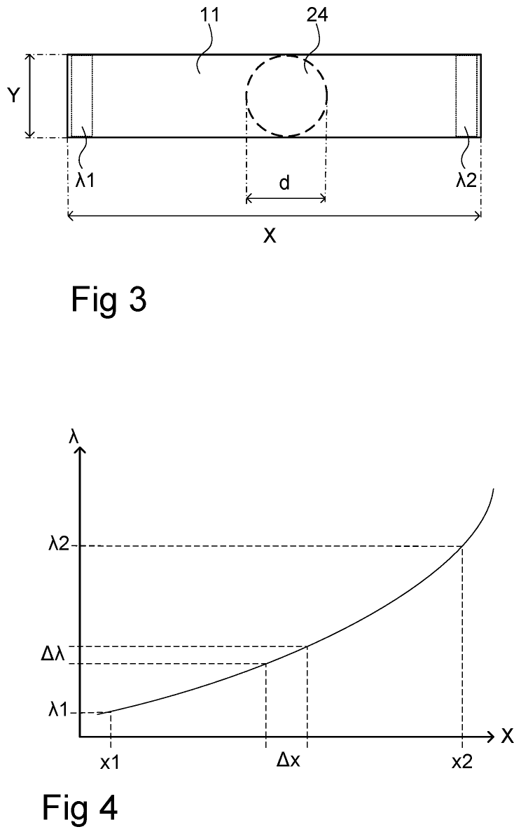

FIG. 3 schematically illustrates an optical filter 11, which has a first longitudinal direction X and a second width direction Y. The second width direction Y may be perpendicular to the first longitudinal direction X. Here, both the first X and second directions Y may be in a filter plane of the optical filter 11.

The optical filter 11 has a wavelength transmission which varies continuously along the first direction X from a first lower wavelength transmission λ1 to an upper wavelength transmission λ2.

The wavelength transmission may vary linearly along the first direction X. Alternatively, the wavelength transmission may vary non-linearly along the first direction X, such as exponentially.

Along the second direction Y, the wavelength transmission may be substantially constant.

In the devices illustrated with reference to FIGS. 1 and 2, the filter would typically be positioned with the first direction X parallel with the movement direction D.

The transmission wavelength may vary over a range of at least one of 200-250 nm, 250-300 nm, 300-350 nm, 350-400 nm, 400-450 nm or 450-500, 500-550 nm, 550-600 nm, 600-650 nm, 650-700 nm, 700-750 nm, 750-800 nm, 800-850 nm, 850-900 nm, 900-950 nm, 950-1000 nm, 1000-1050 nm, 1050-1100 nm, 1100-1150 nm, 1150-1200 nm, 1200-1250 nm, 1250-1300 nm, 1300-1350 nm, 1350-1400 nm, 1400-3000 nm (SWIR), 3000-8000 nm (MWIR), 8000-15000 nm (LWIR) or 15000-1000000 nm (FIR).

Such filters 11 are known as such and may are sold by Delta Optical Thin Film A/S under the designations “continuously variable filters”, “CVF” or “linear variable filters”.

In FIG. 3, there is indicated an aperture 24, having a diameter d. The diameter may correspond to a width of the optical filter 11 along the first direction X.

By moving the optical filter 11 relative to the aperture 24, light of different wavelengths may pass through different portions of the optical filter 11, each portion corresponding to a certain transmission wavelength. A plurality of images comprising information of light of different wavelengths may be acquired during the movement of the optical filter 11. A hyperspectral image may be generated by combining the plurality of images.

Moreover, if the optical filter 11 is applied to a camera having a very small aperture and/or lens, as shown in FIG. 3, the variation in transmission wavelength over the diameter d of the aperture 24 is, for many applications, negligible. Hence, by using the optical filter 11 having continuously variable transmission wavelength together with the camera having a very small aperture 24, it is possible to achieve images of a large number of wavelength bands, for generating a hyperspectral image.

For example, if a filter having an effective length of 36 mm along the first direction X is used with a camera having an aperture of 2 mm, it is possible to achieve an 18-band hyperspectral image capture, wherein the 18 bands are close to, or essentially, non-overlapping.

As another example, if 50% overlap is accepted, the same optical filter and camera aperture would provide a 36-band hyperspectral image capture.

Hence, a large number of bands may be achieved using a compact imaging device.

An effective filter width, e.g., a diameter of an aperture or a lens of a camera, across the first direction may be less than 10% of an effective filter length along the first direction X. For example, if the length of the optical filter is 36 mm, a maximal length of the effective filter width may be 3.6 mm.

For example, a CVF may have a size of 24 mm*36 mm, wherein the length of the optical filter 11 along the first direction X is 36 mm. If the aperture is 2 mm, the CVF may be divided into 12 identical CVFs, each having a size of 2 mm*36 mm. Since it is known that the filter is one of the most expensive elements of a hyperspectral camera, using a smaller sized CVF may reduce the cost for such hyperspectral camera.

FIG. 4 schematically illustrates a filter characteristic of an optical filter having exponentially varying transmission wavelength.

The x-axis of FIG. 4 indicates a position x of the optical filter 11 along the first direction X. The position x of the optical filter 11 along the first direction X may be a distance x from one end of the optical filter 11 along the first direction X. The y-axis of FIG. 4 indicates a transmission wavelength λ of the optical filter 11 at position x of the optical filter 11 along the first direction X.

At position x1 along the first direction X, the transmission wavelength is λ1 and at position x2 along the first direction X, the transmission wavelength is λ2. The relationship between these two sets of points in the graph (x1, λ1) and (x2, λ2) may be used to determine whether the transmission wavelength of the optical filter 11 varies substantially linearly and/or exponentially. By knowing how the transmission wavelength of the optical filter 11 varies, it is possible to determine the transmission wavelength at any position along the first direction X. Hence, at any given interval Δx along the first direction, there is an associated corresponding wavelength transmission interval Δλ.

The CVFs are originally developed for mounting directly on an image sensor, wherein each sensor element would be reached by light only within a narrow wavelength band since a length/width of a sensor element is very small comparing to a length/width of the optical filter 11, e.g., by a factor of at least several thousands.

A length of the sensor element along the first direction X of the optical filter 11 may be denoted Δx in FIG. 4. The varied transmission wavelength corresponding to the distance Δx along the first direction X may be denoted Δλ in FIG. 4. From FIG. 4, it is clear that the larger the Δx, the larger the ΔA. That is, the larger the length of the sensor element, the larger the variation of the transmission wavelength, and consequently, the lower the spectral resolution. That is, to keep a reasonable spectral resolution, Δx must be a small fraction of a length of the optical filter 11 along the first direction X. In other words, the variation of the transmission wavelength Δλ of the light passing through the filter must be small enough to provide a sufficiently good spectral resolution.

The CVF may have a size of 24 mm*36 mm, wherein the length of the optical filter 11 along the first direction X is 36 mm. Until recently, it has always been unfeasible to place such CVFs in front of an aperture/lens instead of the image sensor, since Δx, e.g., a diameter of the aperture/lens, would then be larger than the length of the optical filter 11 along the first direction X, e.g., 36 mm, rather than being a small fraction of the length. In other words, if such CVF is used together with a camera having a big aperture (e.g., 36 mm), the variation of the transmission wavelength Δλ of the light passing through the filter would be the full band of the CVF, and the resulting images would have a low spectral resolution. Since all the spectral information is mixed together, such images are useless for generating hyperspectral images or performing any other spectral analysis.

However, along with the development of small sized and inexpensive camera systems, e.g., for smartphones, the diameter of apertures has been reduced dramatically to about 1-3 mm. Thus, such cameras with tiny apertures make it possible to place such CVFs outside the camera, i.e. in front of an aperture/lens, instead of within in the camera on the image sensor, as the diameter of the aperture/lens Δx (e.g., 1-3 mm), would be a small fraction of the length of the optical filter 11 along the first direction X, e.g., 36 mm. That is, the variation of the transmission wavelength Δλ of the light passing through the filter would be a small band compared with the full band of the CVF, and the resulting images would have a good spectral resolution for generating a hyperspectral image.

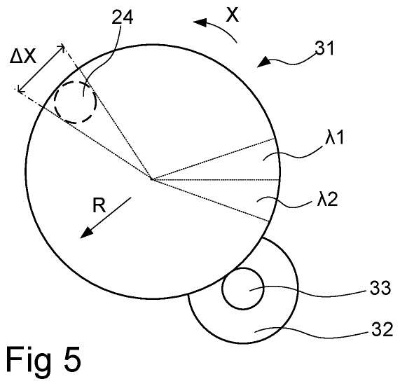

FIG. 5 schematically illustrates an alternative optical filter 31, which is circular and having a transmission wavelength which varies continuously along a circumference direction X. Along a radial direction R, which is perpendicular to the first direction X, the transmission wavelength may be constant.

Hence, the wavelength transmission may vary from a first lower wavelength transmission λ1 to an upper wavelength transmission λ2. At a point where the lower wavelength transmission λ1 and the upper wavelength transmission λ2 meet, there may be a step formation.

The features of the optical filter 11 of FIG. 3 may analogously applicable to the optical filter 31 of FIG. 5.

FIG. 5 also illustrates the aperture 24 and the actuator 32, as well as the optional transmission mechanism 33. The transmission mechanism 33 may comprise a friction wheel or a gearwheel. Alternatively, the optical filter 31 may be rotatable about an axis that is concentric with a rotation axis of an actuator 32 motor.

In either embodiment, the actuator 12, 32 may be a step motor, which is configured to move in a stepwise manner.

Optionally, the filter device 2, 3 may be provided with a position sensor by which a filter position can be determined. To this end, a filter edge may be provided with a Gray code arrangement or a Hall effect sensor.

A calibration device may be provided. The calibration device may be configured to provide at least one light of a predetermined wavelength passing through the optical filter. The calibration device may comprise a light source 16, which may emit light of one or more predetermined wavelength(s), which wavelength(s) is within the transmission wavelength range of the optical filter 11. Optionally, a closure device, for closing the inlet aperture 17, 31 may be provided, so as to ensure that only light from the light source 16 is transmitted towards the optical filter 11 during calibration.

With the provided light, it is possible to determine a position along the first direction X of the optical filter 11, which position has a transmission wavelength corresponding to the predetermined wavelength, since it would be known where along the filter that particular wavelength would be transmitted. Thus, the optical filter 11 and/or the actuator 12 may be calibrated based on the determined position.

The light may be provided by the light source 16 and optionally an optical filter device providing one or more limited transmission wavelengths or an optical reflecting device providing one or more limited reflection wavelengths.

In connection with the example of FIG. 1, a method of acquiring a hyperspectral image, will be discussed in more detail.

A camera 2 having an image sensor 22 and a camera lens 21 defining an optical axis A of the camera, is provided. An optical filter 11, having continuously variable transmission wavelength along a first direction X is provided. A first image of a scene is acquired while the optical filter 11 is in a first position relative to the optical axis A. Then, the optical filter 11 is moved relative to the optical axis A along the first direction X by means of an actuator 12. A second image of the scene is acquired, while the optical filter 11 is in a second position, spaced from the first position, relative to the optical axis A.

Thus, two images of the scene may be acquired by the camera 2, while the two images comprise information of the different wavelength of the incoming light. These two images can be used to generate a hyperspectral image by any known method.

The method may comprise repeating the step of moving the optical filter 11 and the step of acquiring a second image, a predetermined number of times. Such predetermined number of times may be 5-40, preferably 10-36. Then, a plurality of images comprising information of the different wavelength of the incoming light may be acquired, and used for generating a hyperspectral image.

The step of moving the optical filter may comprise moving the optical filter 11 by a distance along the first direction X which corresponds to 50-150% of a minimum, or effective, aperture cross section, perpendicular to the optical axis A.

The step of moving the optical filter 11 may comprise moving the optical filter 11 by a predetermined distance along the first direction X. For example, in order to compute the Structure Insensitive Pigment Index (SIPI), providing a measure of the efficiency with which vegetation can use incident light for photosynthesis, light at the wavelengths 445, 680, and 800 nm are needed. Thus, the optical filter 11 may be moved to three different positions along the first direction corresponding to these wavelengths, and the camera 2 may capture three images at the three different positions, respectively.

The resulting images and/or the generated hyperspectral images may be used as an intermediate step for many applications. For example, if a SIPI image is desired, the SIPI image would be computed directly based on the three images taken at the three different positions.

The camera 2 may be substantially stationary relative to the scene during and between said first and second acquiring steps. Substantially stationary means that the camera 2 is held in a fixed position relative to the scene, but for such movements as may be compensated for by mechanical and/or electronic motion compensation techniques.

Alternatively, or in combination, the hyperspectral image can be achieved by using a burst mode, also known as a continuous shooting mode, a sports mode or a continuous high speed mode, of the camera. In burst mode, the camera 2 can capture several images in quick succession, such that the movement of the camera 2 can be ignored.

The method may comprise the camera controller 23 transmitting a burst scheme to the filter controller 14 prior to acquiring an image, whereby the filter controller 14 controls the movement of the optical filter in accordance with the burst scheme. A burst scheme may comprise data indicating a starting point, movement distance, movement timing and number of movements.

The method may comprise a movement compensation step, for compensating movement of the camera 2 relative to the scene during and between said first and second acquiring steps.

If there is relative movement between the camera 2 and the scene while capturing the images, the images comprising information of different wavelength bands cannot be perfectly co-aligned. There are known methods enabling fast image registration (alignment), could be used for compensating for movement.

The method may comprise receiving, by a filter controller 14, a trigger signal from a camera controller 23, and carrying out said step of moving the optical filter based on said trigger signal.

Since it is the camera 2 which acquires images, the trigger signal may be used to initialize and/or synchronize the image acquisition and the movement of the optical filter 11 by controlling the actuator 12 through the filter controller 14. Thus, the image acquisition and the movement of the optical filter 11 may be in a correct order and timing.

Alternatively, it is possible to cede control of the filter device to the camera controller, such that the movements of the filter may be controlled entirely by the camera controller.

In connection with example of FIG. 1, a method of calibrating a filter device 1, will be discussed in more detail.

A camera 2 having an image sensor 22 and a camera lens 21 defining an optical axis A of the camera, is provided. An optical filter 11, having continuously variable transmission wavelength along a first direction X is provided. Then, light of at least one predetermined wavelength through the optical filter 11 is acquired by the image sensor 22. A filter position along the first direction X is associated with said predetermined wavelength.

The light may be provided by one or more light sources 16 with known wavelengths. Such light sources may be integrated with the filter device 1 or the camera 3. Alternatively, a separate calibration light source device (not shown) may be provided. The light source 16 may be arranged to direct light directly through the filter towards the light sensor. Alternatively, the light source may direct light via a reflector, which may, as a non-limiting example, be provided on an inside of a filter aperture protection closure, by which the first aperture 11, 31 may be covered.

Thus, for the predetermined transmission wavelength, the corresponding filter position having the predetermined transmission wavelength can be determined.

The method may comprise storing the filter position and its associated wavelength, e.g., in a memory of the camera 2 or of the filter controller. The filter position and its associated wavelength may be stored as a look-up table.

The method may comprise repeating the step of acquiring light of one predetermined wavelength through the optical filter 11 and the step of associating a filter position, for a predetermined number of times. Then, a plurality of pairs of filter positions and their transmission wavelengths can be determined.

The method may comprise determining the transmission wavelengths for each filter position, e.g., by interpolation.

With the calibration method, the camera 2 can determine the transmission wavelength of the optical filter 11 of an unknown filter device 1 attached to the camera 2.

Based on the calibration result, the filter controller may accurately control the movement of the optical filter 11. For example, if a hyperspectral image is to be generated for green plants, the actuator may control the optical filter 11 to move only around the range corresponding to the wavelength of interested, rather than the full band of the optical filter 11.

Again, the control of the calibration may be performed by the filter controller or by the camera controller.

It is understood that methods disclosed with reference to FIG. 1 are applicable also to the device disclosed in FIG. 2, however with the modification, that in the device of FIG. 2, the filter controller may be abolished altogether, with all of its functions being managed by the camera controller.

Moreover, it is noted that the disclosure with regard to the linear optical filter 11 applies also to the circular optical filter 31

1. A filter device for acquiring a hyperspectral image, comprising:
a filter device frame,
an optical filter, and
an actuator, configured to control, relative to the frame, a position of the optical filter along a first direction,
characterized in that
the optical filter presents continuously variable transmission wavelength along the first direction.

2. The filter device as claimed in claim 1, wherein the optical filter has a constant transmission wavelength in a second direction, perpendicular to the first direction; and/or
wherein the transmission wavelength varies between a lower transmission wavelength and an upper transmission wavelength, wherein the upper transmission wavelength is greater than the lower transmission wavelength; and/or
wherein the transmission wavelength varies over a range of at least one of 200-250 nm, 250-300 nm, 300-350 nm, 350-400 nm, 400-450 nm or 450-500, 500-550 nm, 550-600 nm, 600-650 nm, 650-700 nm, 700-750 nm, 750-800 nm, 800-850 nm, 850-900 nm, 900-950 nm, 950-1000 nm, 1000-1050 nm, 1050-1100 nm, 1100-1150 nm, 1150-1200 nm, 1200-1250 nm, 1250-1300 nm, 1300-1350 nm, 1350-1400 nm, 1400-3000 nm (SWIR), 3000-8000 nm (MWIR), 8000-15000 nm (LWIR) or 15000-1000000 nm (FIR).

3. (canceled)

4. (canceled)

5. The filter device as claimed in claim 1, wherein the first direction is linear and wherein an effective optical filter width across the first direction is less than 10%, preferably less than 6% or less than 5% of an effective filter length along the first direction.

6. The filter device as claimed in claim 1, wherein the first direction is circular, preferably the filter device further comprises a camera attachment device.

7. The filter device as claimed in claim 1, further comprising a filter controller, configured to:
receive a trigger signal, and
in response to the trigger signal, provide a control signal to the actuator to cause the optical filter to move along said first direction, preferably the filter device further comprises a camera attachment device.

8. The filter device as claimed in claim 1, further comprising a calibration device, configured to provide at least one light of a predetermined wavelength through the optical filter.

9. The filter device as claimed in claim 1, further comprising a filter housing enclosing the optical filter and the actuator.

10. The filter device as claimed in claim 9, wherein the housing presents an inlet aperture upstream of the optical filter and an outlet aperture downstream of the optical filter.

11. (canceled)

12. A system for acquiring a hyperspectral image, comprising:
a camera having an image sensor and a camera lens defining a camera optical axis,
a filter device as claimed in claim 1, arranged such that the optical filter is movable across the camera optical axis, and
a camera housing, enclosing said image sensor and said optical filter.

13. The system as claimed in claim 12,
wherein the filter device further comprises a filter housing enclosing the optical filter and the actuator;
wherein the filter housing is releasably connectable to the camera housing.

14. The system as claimed in claim 12, wherein an aperture dimension along the first direction, perpendicular to the optical axis is less than 20% of an effective filter length along the first direction, preferably less than 15%, less than 10%, less than 8% or less than 6%.

15. The filter device as claimed in claim 14, wherein a filter transmission wavelength of the optical filter varies less than 30 nm, preferably less than 20 nm, less than 15 nm, less than 10 nm, less than 5 nm, less than 2 nm or less than 1 nm over a length of the filter along the first direction, which length corresponds to the minimum aperture cross section.

16. The system as claimed in claim 12, wherein a camera aperture is 1-3 mm along the first direction, preferably 1-1.5 mm, 1.5 mm-2 mm, 2 mm-2.5 mm or 2.5 mm-3 mm.

17. The system as claimed in claim 12, wherein the camera comprises a camera controller, which is configured to control the actuator.

18. A method of acquiring a hyperspectral image, comprising:
providing a camera having an image sensor and a camera lens defining an optical axis of the camera,
providing an optical filter, having continuously variable transmission wavelength along a first direction,
acquiring a first image of a scene, while the optical filter is in a first position relative to the optical axis,
moving the optical filter relative to the optical axis along the first direction by means of an actuator, and
acquiring a second image of the scene, while the optical filter is in a second position, spaced from the first position, relative to the optical axis.

19. The method as claimed in claim 18, further comprising repeating the step of moving the optical filter and the step of acquiring a second image a predetermined number of times.

20. The method as claimed in claim 18, wherein the step of moving the optical filter comprises moving the optical filter by a distance along the first direction which corresponds to 50-150% of a camera aperture dimension along the first direction, perpendicular to the optical axis.

21. The method as claimed in claim 18, wherein the camera is substantially stationary relative to the scene during and between said first and second acquiring steps.

22. The method as claimed in claim 18, further comprising receiving, by a filter controller, a trigger signal from a camera controller, and carrying out said step of moving the optical filter based on said trigger signal.

23. The method as claimed in claim 22, further comprising carrying out a plurality of steps of moving and steps of acquiring the second image in response to a single trigger signal.

24. (canceled)
